(19) United States
(12) Patent Application Publication
(10) Pub. No.: US 2017/0199712 A1
(43) Pub. Date: Jul. 13, 2017

(54) ELECTRONIC DEVICE AND METHOD OF RECOGNIZING WEARING FORM THEREOF

(71) Applicant: SAMSUNG ELECTRONICS CO., LTD., Suwon-si (KR)

(72) Inventor: Wonwook LEE, Hwaseong-si (KR)

(21) Appl. No.: 15/404,533

(22) Filed: Jan. 12, 2017

(30) Foreign Application Priority Data
Jan. 12, 2016 (KR) 10-2016-0003604

(51) Int. Cl. G06F 3/14; G01B 7/16; G06F 1/16

(52) U.S. Cl. CPC G06F 3/14; G06F 1/1652; G06F 1/1677; G01B 7/22; H04M 1/72569

(57) ABSTRACT

An electronic device and a method of recognizing a form of the electronic device are provided. The electronic device comprises: a housing that bends in at least one direction; a first member comprising a first surface, the first member being fixed to the housing or a first point within the housing; a second member comprising a second surface, the second member being fixed to the housing separated in the at least one direction from the first point or a second point within the housing and arranged to overlap with at least a portion of the first member; and a detection circuit configured to detect a relative location of the first member and the second member, wherein a first distance between the first point and the second point when the housing is in a flat state is different from a second distance between the first point and the second point when the housing is in a bent state in the at least one direction. Various embodiments of the present disclosure are possible.

### CROSS-REFERENCE TO RELATED APPLICATION

The present application is based on and claims priority under 35 U.S.C. §119 to a Korean patent application filed on Jan. 12, 2016, in the Korean Intellectual Property Office and assigned Serial number 10-2016-0003604, the disclosure of which is incorporated by reference herein in its entirety.

### BACKGROUND

Field

The present disclosure relates generally to an electronic device implemented into various forms.

Description of Related Art

Nowadays, while still being able to perform the same function or more various functions, electronic devices are gradually being developed to be formed in a small size and a thin thickness to be easily carriable. In order to further reinforce portability and convenience while satisfying a user's desires, such small portable electronic devices have been developed in a new form in view of hardware or software. For example, the electronic device may be worn at a wrist, a head, or an arm of a human body.

A wearable device that may be worn by a human or attached to various structures may include a main body for performing an original function of an electronic device and at least one strap taken out by a predetermined length from the main body to fix to a human body or various structures.

With the conventional method of recognizing a form of a wearable device using a flexible display, a folded state in folding/unfolding of a flexible display, for example only an on/off state of a flexible display may be determined using a combination of a Hall sensor and a magnet applied to an existing folder (feature) phone. In this case, a magnetization problem may occur because a magnet is used.

### SUMMARY

The present disclosure addresses the above problems and provides a method of determining and using an on/off state and a bending state of an electronic device without a magnetization problem.

In accordance with an example aspect of the present disclosure, an electronic device, comprises: a housing configured to bend in at least one direction; a first member comprising a first surface, the first member being fixed to the housing or a first point within the housing; a second member comprising a second surface, the second member being fixed to the housing separated in the at least one direction from the first point or a second point within the housing and arranged to overlap with at least a portion of the first member; and a detection circuit configured to detect a relative location of the first member and the second member, wherein a first distance between the first point and the second point when the housing is in a flat state is different from a second distance between the first point and the second point when the housing is in a bent state in the at least one direction.

In accordance with an another example aspect of the present disclosure, a method of recognizing a form of an electronic device comprising a housing bent in any one direction, a first member comprising a first surface, the first member being fixed to the housing or within the housing, and a second member comprising a second surface, the second member being arranged to overlap with at least a portion of the first member, at least one of the first and second members being arranged to move relative to the other member, the method comprises: detecting a relative location of the first and second members based on one or more of a folding and a rolling state of the housing; and determining a level in which the housing is bent in the any one direction based on the relative location of the first member and the second member.

### BRIEF DESCRIPTION OF THE DRAWINGS

The above and other aspects and attendant advantages of the present disclosure will become more readily apparent from the following detailed description, taken in conjunction with the accompanying drawings, in which like reference numerals represent like elements, and wherein:

FIG. 1 is a block diagram illustrating an example configuration of an electronic device in a network environment according to an example embodiment of the present disclosure;

FIG. 2 is a block diagram illustrating an example configuration of an electronic devece according to an example embodiment of the present disclosure;

FIG. 3 is a block diagram illustrating an example configuration of a programming module according to an example embodiment of the present disclosure;

FIG. 4 is a front perspective view illustrating an example electronic device according to various example embodiments of the present disclosure;

FIG. 5 is a rear perspective view illustrating an example electronic device according to various example embodiments of the present disclosure;

FIGS. 6A and 6B are a perspective views illustrating various example bending states of an electronic device according to various example embodiments of the present disclosure;

FIG. 7 is a diagram illustrating an example state in which an electronic device is worn at a wrist as a wearable device according to various example embodiments of the present disclosure;

FIGS. 8A and 8B are diagrams illustrating an example structure that detects bending of an electronic device according to various example embodiments of the present disclosure;

FIG. 9 is a circuit diagram illustrating a first example of a structure that detects bending of an electronic device according to various example embodiments of the present disclosure;

FIGS. 10A and 10B are circuit diagrams illustrating a second example of a structure that detects bending of an electronic device according to various example embodiments of the present disclosure;

FIG. 11 is a schematic diagram illustrating an example structure that detects bending of an electronic device according to various example embodiments of the present disclosure;

FIG. 12 is a schematic diagram illustrating an example structure that detects bending of an electronic device according to various example embodiments of the present disclosure;

FIG. 13 is a cross-sectional diagram illustrating a first mounting example of a structure that detects bending of an electronic device according to various example embodiments of the present disclosure;

FIG. 14 is a cross-sectional diagram illustrating a second mounting example of a structure that detects bending of an electronic device according to various example embodiments of the present disclosure; and

FIG. 15 is a flowchart illustrating an example method of recognizing a wearing form of an electronic device according to various example embodiments of the present disclosure.

### DETAILED DESCRIPTION

Hereinafter, the present disclosure will be described with reference to the accompanying drawings. Although various example embodiments are illustrated in the drawings and related detailed descriptions are discussed in the present disclosure, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

The expression “configured to” uses in the present disclosure may be replaced, according to situations, with “suitable for”, “having the capacity to”, “designed to”, “adapted to”, “made to”, or “capable of”. The term “configured to” may not always refer to “specially designed to”. In some situations, “device configured to” may refer to a situation in which the device can “do something” with other devices or components. For example, a context “processor configured to execute A, B, and C” may refer, for example, to a dedicated processor (for example, embedded processor) for executing a corresponding operation, or a generic-purpose processor or processing circuitry (for example, CPU or application processor) capable of executing corresponding operations by using at least one software program stored in a memory device.

The terms used in the present disclosure is to merely describe various example embodiments, and is not intended to limit the scope of other embodiments. A singular form may include a plural form. All the terms including a technical or scientific term may have the same meaning as terms generally understood by those skilled in the prior art. The terms defined in a general dictionary may be interpreted as having the same or similar meaning in a context of related technology, and are not interpreted abnormally or excessively unless clearly defined in the present disclosure. According to situations, even where terms are defined in the present disclosure they should not be interpreted as excluding the embodiments of the present disclosure.

An electronic device according to various embodiments of the present disclosure may be a device including a projection or a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch, or the like, but is not limited thereto.

According to some embodiments, the electronic device may be a smart home appliance having a projection function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame, or the like, but is not limited thereto.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops, or the like, but is not limited thereto.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a projection function, or the like, but is not limited thereto. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices

The example embodiments disclosed in the description and drawings are merely presented to easily describe technical contents of the present disclosure and help the understanding of the present disclosure and are not intended to limit the scope of the present disclosure. Therefore, all changes or modifications derived from the technical idea of the present disclosure as well as the embodiments described herein should be interpreted to belong the scope of the present disclosure.

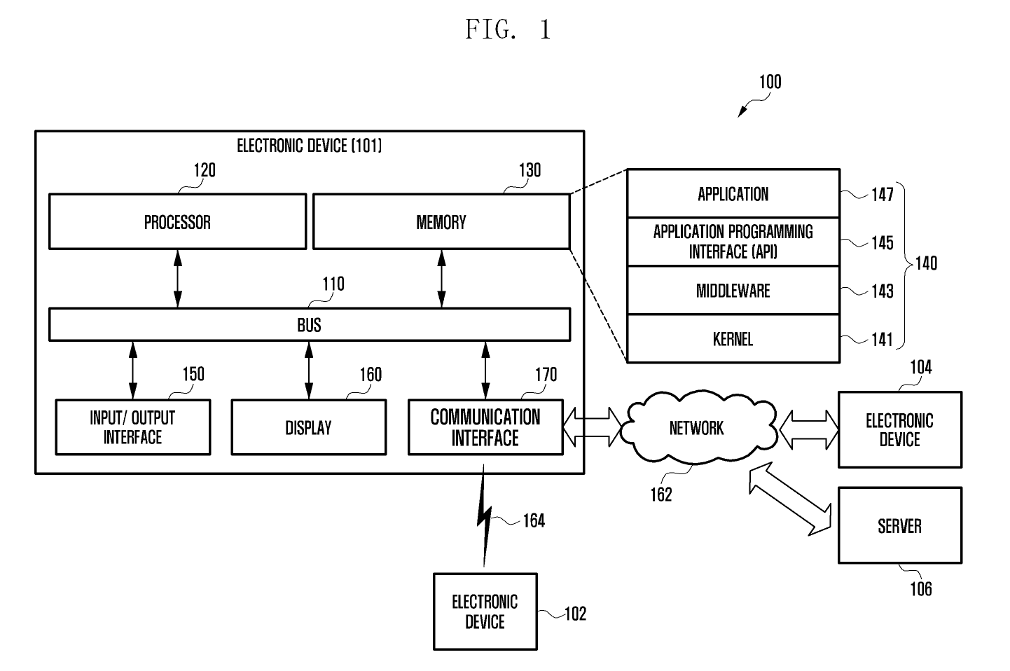

FIG. 1 is a block diagram illustrating an example configuration of an electronic device in a network environment according to an example embodiment of the present disclosure.

Referring to FIG. 1, the electronic device 100 may include a bus 110, a processor (e.g., including processing circuitry) 120, a memory 130, an input/output interface (e.g., including input/output circuitry) 150, a display 160, a communication interface (e.g., including communication circuitry) 170, and other similar and/or suitable components.

The bus 110 may be a circuit which interconnects the above-described elements and delivers a communication (e.g., a control message) between the above-described elements.

The processor 120 may include various processing circuitry configured to receive commands from the above-described other elements (e.g., the memory 130, the user input/output interface 150, the display module 160, the communication interface 170, etc.) through the bus 110, may interpret the received commands, and may execute calculation or data processing according to the interpreted commands.

The memory 130 may store commands or data received from the processor 120 or other elements (e.g., the user input/output interface 150, the display module 160, the communication interface 170, etc.) or generated by the processor 120 or the other elements. The memory 130 may include programming modules 140, such as a kernel 141, middleware 143, an Application Programming Interface (API) 145, an application 147, and the like. Each of the above-described programming modules may be implemented in software, firmware, hardware, or a combination of two or more thereof.

The kernel 141 may control or manage system resources (e.g., the bus 110, the processor 120, the memory 150, etc.) used to execute operations or functions implemented by other programming modules (e.g., the middleware 143, the API 145, and the application 147). Also, the kernel 141 may provide an interface capable of accessing and controlling or managing the individual elements of the electronic device 100 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications 147 and/or the middleware 143, for example, may perform load balancing of the work requests by using a method of assigning a priority, in which system resources (e.g., the bus 110, the processor 120, the memory 150, etc.) of the electronic device 100 can be used, to at least one of the one or more applications 147.

The API 145 is an interface through which the application 147 is capable of controlling a function provided by the kernel 141 or the middleware 143, and may include, for example, at least one interface or function for file control, window control, image processing, character control, or the like.

The input/output interface 150, for example, may include various input/output circuitry configured to receive a command or data as input from, for example, a user, and may deliver the received command or data to the processor 120 or the memory 130 through the bus 110. The display module 160 may display a video, an image, data, or the like to the user.

The communication interface 170 may include various communication circuitry configured to connect communication 164 between another electronic device 102 and the electronic device 100. The communication interface 170 may support a predetermined short-range communication protocol (e.g., Wi-Fi, BlueTooth (BT), and Near Field Communication (NFC)) 164, or predetermined network communication 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 100. Further, the communication interface 170 may connect communication between a server 106 and the electronic device 100 via the network 162.

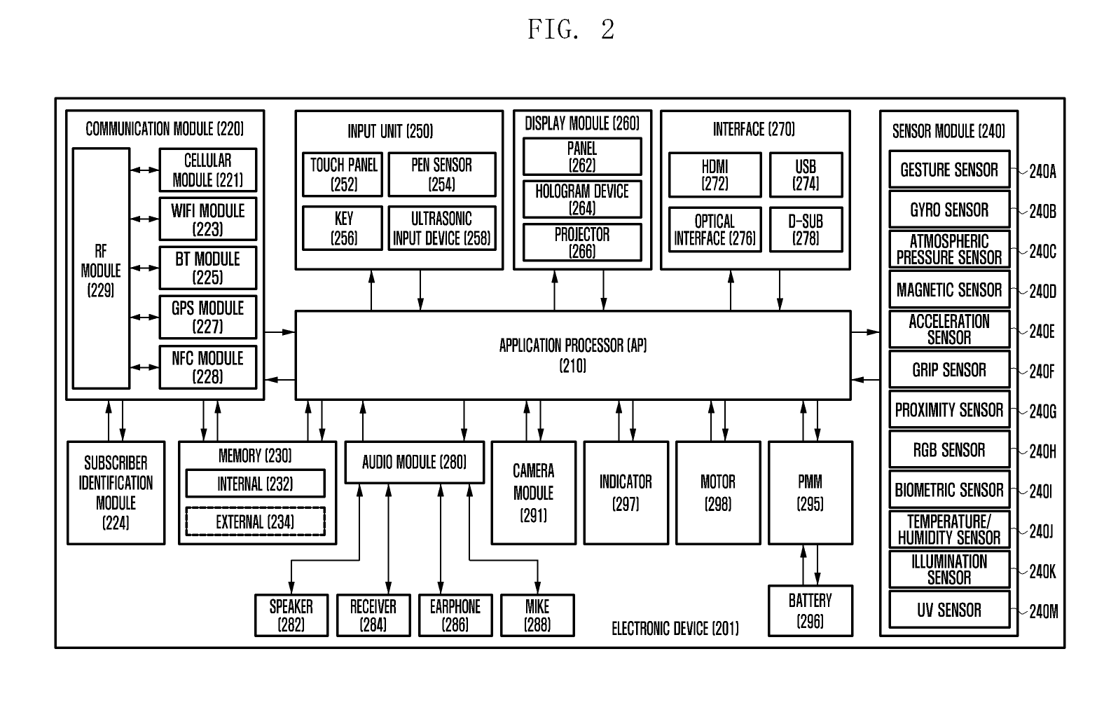

FIG. 2 is a block diagram illustrating an example configuration of an electronic device 201 according to an example embodiment of the present disclosure.

The electronic device 201 may be, for example, a hardware of the electronic device 100 illustrated in FIG. 1.

Referring to FIG. 2, the electronic device 201 may include one or more processors (e.g., including processing circuitry) 210, a Subscriber Identification Module (SIM) card 224, a memory 230, a communication module (e.g., including communication circuitry) 220, a sensor module 240, an input unit (e.g., including input circuitry) 250, a display module 260, an interface (e.g., including interface circuitry) 270, an audio module 280, a camera module 291, a power management module 295, a battery 296, an indicator 297, a motor 298 and any other similar and/or suitable component.

The processor 210 (e.g., the processor 120) may include various processing circuitry, such as, for example, and without limitation, one or more dedicated processors, CPUs, Application Processors (APs), or one or more Communication Processors (CPs). The processor 210 may be, for example, the processor 120 illustrated in FIG. 1. The AP and the CP are illustrated as being included in the processor 210 in FIG. 2, but may be included in different Integrated Circuit (IC) packages, respectively. According to an embodiment of the present disclosure, the AP and the CP may be included in one IC package.

The AP may execute an Operating System (OS) or an application program, and thereby may control multiple hardware or software elements connected to the AP and may perform processing of and arithmetic operations on various data including multimedia data. The AP may be implemented by, for example, a System on Chip (SoC). According to an embodiment of the present disclosure, the processor 210 may further include a Graphical Processing Unit (GPU) (not illustrated).

The CP may manage a data line and may convert a communication protocol in the case of communication between the electronic device (e.g., the electronic device 100) including the hardware of the electronic device 201 and different electronic devices connected to the electronic device through the network. The CP may be implemented by, for example, a SoC. According to an embodiment of the present disclosure, the CP may perform at least some of multimedia control functions. The CP, for example, may distinguish and authenticate a terminal in a communication network by using a subscriber identification module (e.g., the SIM card 224). Also, the CP may provide the user with services, such as a voice telephony call, a video telephony call, a text message, packet data, and the like.

Further, the CP may control the transmission and reception of data by the communication module 220. In FIG. 2, the elements such as the CP, the power management module 295, the memory 230, and the like are illustrated as elements separate from the AP. However, according to an embodiment of the present disclosure, the AP may include at least some (e.g., the CP) of the above-described elements.

According to an embodiment of the present disclosure, the AP or the CP may load, to a volatile memory, a command or data received from at least one of a non-volatile memory and other elements connected to each of the AP and the CP, and may process the loaded command or data. Also, the AP or the CP may store, in a non-volatile memory, data received from or generated by at least one of the other elements.

The SIM card 224 may be a card implementing a subscriber identification module, and may be inserted into a slot formed in a particular portion of the electronic device 100. The SIM card 224 may include unique identification information (e.g., Integrated Circuit Card IDentifier (ICCID)) or subscriber information (e.g., International Mobile Subscriber Identity (IMSI)).

The memory 230 may include an internal memory 232 and/or an external memory 234. The memory 230 may be, for example, the memory 130 illustrated in FIG. 1. The internal memory 232 may include, for example, at least one of a volatile memory (e.g., a Dynamic RAM (DRAM), a Static RAM (SRAM), a Synchronous Dynamic RAM (SDRAM), etc.), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 232 may be in the form of a Solid State Drive (SSD). The external memory 224 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like.

The communication module 220 may include various communication circuitry including, for example, a wireless communication module or a Radio Frequency (RF) module 229. The communication module 220 may be, for example, the communication interface 170 illustrated in FIG. 1. The wireless communication module may include various communication circuitry, such as, for example, and without limitation, a cellular module 221, a Wi-Fi module 223, a BT module 225, a GPS module 227, or a NFC module 228. For example, the wireless communication module may provide a wireless communication function by using a radio frequency. Additionally or alternatively, the wireless communication module may include a network interface (e.g., a LAN card), a modulator/demodulator (modem), or the like for connecting the hardware of the electronic device 201 to a network (e.g., the Internet, a LAN, a WAN, a telecommunication network, a cellular network, a satellite network, a POTS, or the like).

The RF module 229 may be used for transmission and reception of data, for example, transmission and reception of RF signals or called electronic signals. Although not illustrated, the RF module 229 may include, for example, a transceiver, a Power Amplifier Module (PAM), a frequency filter, a Low Noise Amplifier (LNA), or the like. Also, the RF module 229 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green and Blue (RGB) sensor 240H, a biometric sensor 240I, a temperature/humidity sensor 240J, an illumination sensor 240K, and a Ultra Violet (UV) sensor 240M. The sensor module 240 may measure a physical quantity or may sense an operating state of the electronic device 100, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The input module 250 may include various input circuitry, such as, for example, and without limitation, a touch panel 252, a pen sensor 254 (e.g., a digital pen sensor), keys 256, and an ultrasonic input unit 258. The input module 250 may be, for example, the input/output interface 150 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication module 220, through the communication module 220.

The display module 260 may include a panel 262 or a hologram 264. The display module 260 may be, for example, the display module 160 illustrated in FIG. 1. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram device 264 may display a three-dimensional image in the air by using interference of light. According to an embodiment of the present disclosure, the display module 260 may further include a control circuit for controlling the panel 262 or the hologram device 264.

The interface 270 may include various interface circuitry, such as, for example, and without limitation, a High-Definition Multimedia Interface (HDMI) 272, a Universal Serial Bus (USB) 274, an optical interface 276, for example, a projector, and a D-subminiature (D-sub) 278. Additionally or alternatively, the interface 270 may include, for example, SD/Multi-Media Card (MMC) (not illustrated) or Infrared Data Association (IrDA) (not illustrated).

The audio module 280 or codec may bidirectionally convert between a voice and an electrical signal. The audio module 280 may convert voice information, which is input to or output from the audio module 280 or codec, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the hardware 201. Although not illustrated, the power management module 295 may include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor module 240.

Although not illustrated, the hardware 201 may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and the like. Each of the above-described elements of the electronic device 201 according to an embodiment of the present disclosure may include one or more components, and the name of the relevant element may change depending on the type of electronic device. The electronic device 201 according to an embodiment of the present disclosure may include at least one of the above-described elements. Some of the above-described elements may be omitted from the electronic device 201, or the hardware may further include additional elements. Also, some of the elements of the electronic device 201 according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of a dedicated processor, a CPU, an Application-Specific Integrated Circuit (ASIC) chip, a Field-Programmable Gate Array (FPGA), and a programmable-logic device for performing certain operations which have been known or are to be developed in the future.

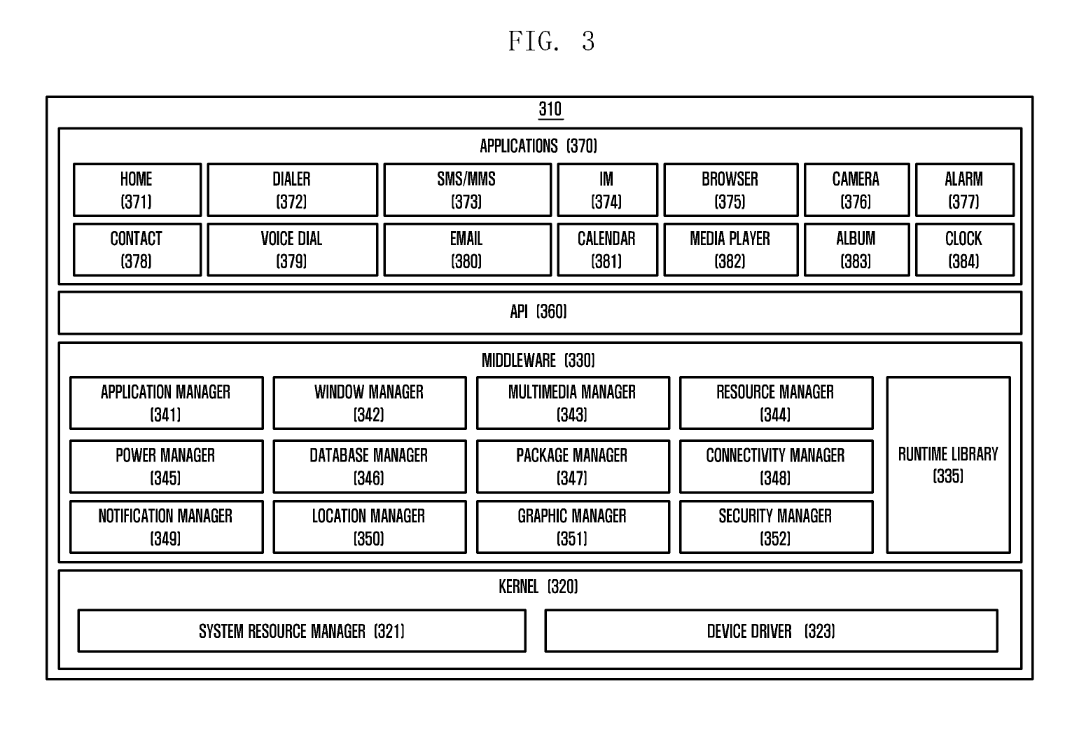

FIG. 3 is a block diagram illustrating an example configuration of a programming module 310 according to an example embodiment of the present disclosure.

The programming module 310 may be included (or stored) in the electronic device 100 (e.g., the memory 130) or may be included (or stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware (e.g., the electronic device 201 of FIG. 2), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or smilar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/ora user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 (e.g., the applications 147) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 300 may be implemented (e.g., executed) by, for example, the one or more processors 210. At least a part of the programming module 310 may include, for example, a module, a program, a routine, a set of instructions, and/or a process for performing one or more functions.

Names of the elements of the programming module (e.g., the programming module 310) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

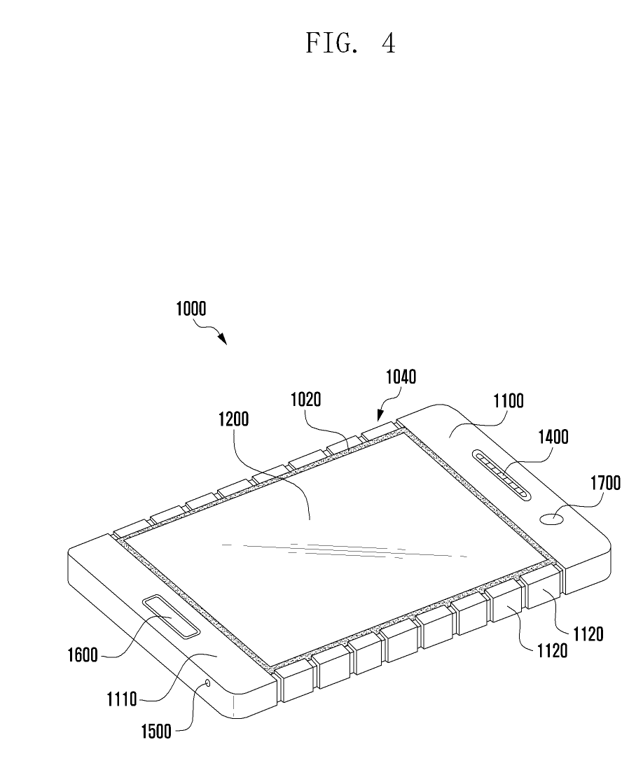

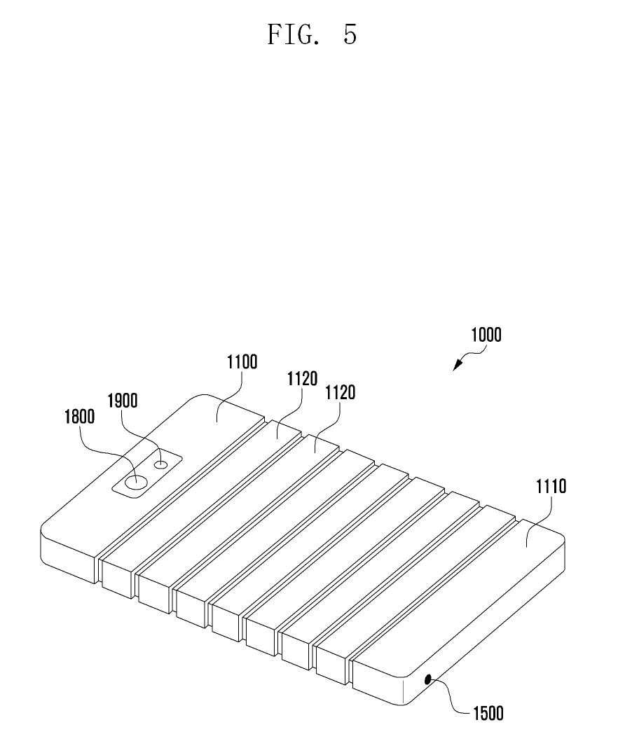

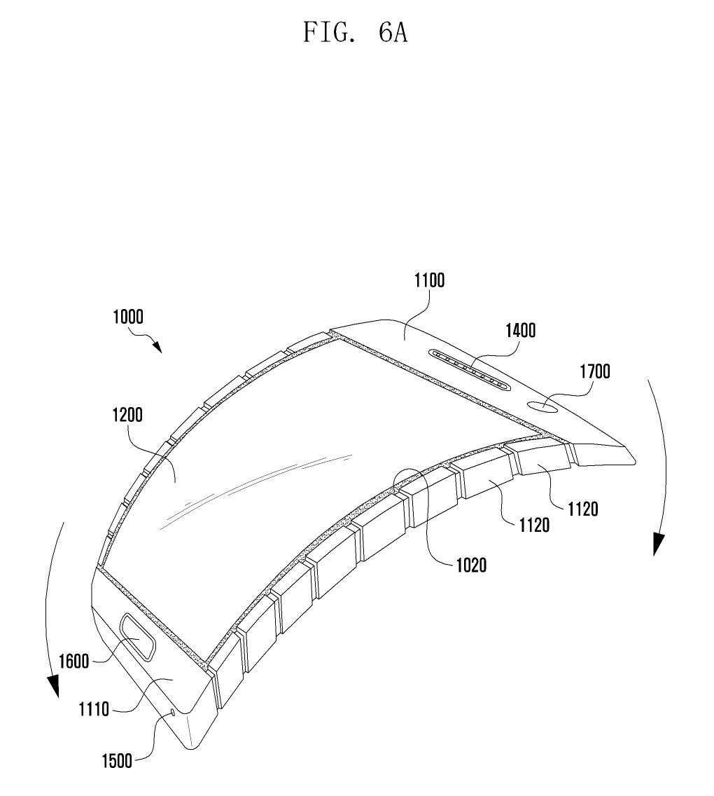

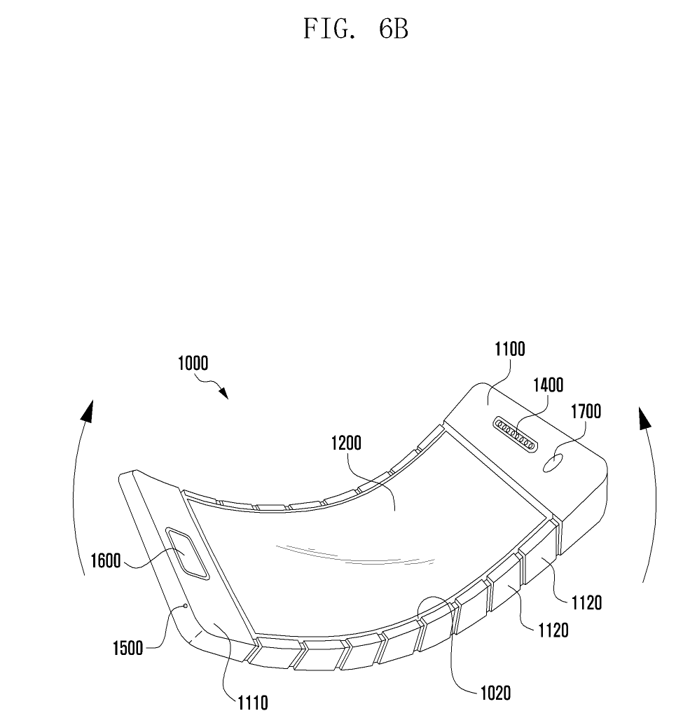

FIG. 4 is a front perspective view illustrating an example electronic device according to various exammple embodiments of the present disclosure, and FIG. 5 is a rear perspective view illustrating an example electronic device according to various example embodiments of the present disclosure. FIGS. 6A and 6B are perspective views illustrating various bending states of an electronic device according to various example embodiments of the present disclosure.

With reference to FIGS. 4 and 5, an electronic device 1000 according to various example embodiments of the present disclosure may be flexible. Further, at one end of the electronic device 1000 according to various example embodiments of the present disclosure, an upper support case frame 1100 is installed, and at the other end thereof, a lower support case frame 1110 is installed, and a plurality of unit case frames 1120 may be moveably connected between the upper support case frame 1100 and the lower support case frame 1110. The unit case frames 1120 may be coupled to each other with various methods and may have a constant movement angle. The electronic device 1000 may be bent in an upper direction or a lower direction by coupling of a plurality of unit case frames 1120.

According to various example embodiments, the upper support case frame 1100 may include a speaker device 1400. The lower support case frame 1110 may include a microphone device 1500. The electronic device 1000 may be used for audio communication or audiovisual communication with another party. According to an example embodiment, the electronic device 1000 may be used as a mobile terminal.

According to an example embodiment, the electronic device 1000 may be used as a smart phone. According to various example embodiments, the upper support case frame 1100 may include a sensor device 1700. The sensor device 1700 may detect a peripheral environment of the electronic device 1000 to perform a corresponding function. According to an example embodiment, an illumination sensor, proximity sensor, or image sensor may be used as the sensor device 1700.

According to various example embodiments, the lower support case frame 1110 may include a physical key button 1600. However, the present disclosure is not limited thereto. For example, the lower support case frame 1110 may include a touch pad instead of the physical key button 1600. According to an exemplary embodiment, a plurality of physical key buttons 1600 may be located at various locations of the electronic device 1000. According to an example embodiment, the physical key button 1600 may be located at a location of at least one of both side surfaces, an upper side surface, and a lower side surface of the electronic device 1000. According to an example embodiment, the physical key button 1600 may be applied to various buttons such as a home button, slip/wake-up mode conversion button, volume up/down button, or function execution button of the electronic device.

According to various example embodiments, the electronic device 1000 may include a display (e.g., a flexible display 1200) disposed at an upper portion of a housing (e.g., a flexible housing 1040) formed by the upper support case frame 1100, the lower support case frame 1110, and a plurality of unit support case frames 1120. According to an example embodiment, the flexible display 1200 may be a touch screen device that can perform data input and output. According to an example embodiment, the display 1200 may include a flexible display module. According to an example embodiment, the display 1200 may further include a flexible window for protecting a display module at an upper portion thereof together with the flexible display module.

According to various example embodiments, the electronic device 1000 may include a display 1200 and a housing 1040 that encloses an outer surface of the display 1200. The housing 1040 may include an upper support case frame 1100, a lower support case frame 1110, and a plurality of unit support case frames 1120; and a damping member 1020 may be included between the unit support case frames 1120. The damping member 1020 may be included in a boundary portion of each of the case frames 1100, 1110, and 1120 along a circumferential edge of the display 1200. According to an example embodiment, the damping member 1020 may include an elastic material that can receive an entire bending level by the plurality of unit case frames 1120. According to an example embodiment, the damping member 1020 may be insert molded in the housing 1040. According to an example embodiment, the damping member 1020 may include an excellent elastic material such as silicon, rubber, or urethane. According to an example embodiment, the damping member 1020 may perform a sealing operation as well as a damping function.

According to various example embodiments, a rear surface of the electronic device 1000 may include a flash device 1900 or at least one camera device 1800. According to an example embodiment, the camera device 1800 may be installed at a front surface of the electronic device and may be used for audiovisual communication. According to an example embodiment, when at least two camera devices 1800 are disposed at a predetermined gap, the camera device 1800 may photograph a three-dimensional image.

According to various example embodiments, the housing 1040 of the electronic device 1000 may be complete only with the plurality of unit case frames 1120 without the upper and lower support case frames 1100 and 1110. Alternatively, an outer surface of the display 1200 may be enclosed with the housing 1040 without the unit case frames 1120.

With reference to FIGS. 6A and 6B, the electronic device 1000 may be bent in a curved shape having a predetermined curvature in an outer direction or an inner direction by a plurality of unit case frames 1120. According to an example embodiment, as illustrated in FIGS. 6A and 6B, the electronic device 1000 may be worn by a human or attached to various structures according to a bent level in any one direction of a vertical direction.

According to various example embodiments, the electronic device 1000 may have a space within the housing 1040 and may include a Printed Circuit Board (PCB) in which various constituent elements of the electronic device 1000, for example various electronic function groups, are mounted and a battery pack for supplying power at such a space. When the electronic device 1000 is implemented, the PCB, the battery pack, and the display 1200 may be bent together with the plurality of unit case frames 1120 and maintain a bent state. According to an example embodiment, the electronic device 1000 may be restored to an original state when an external force is removed in a bent state.

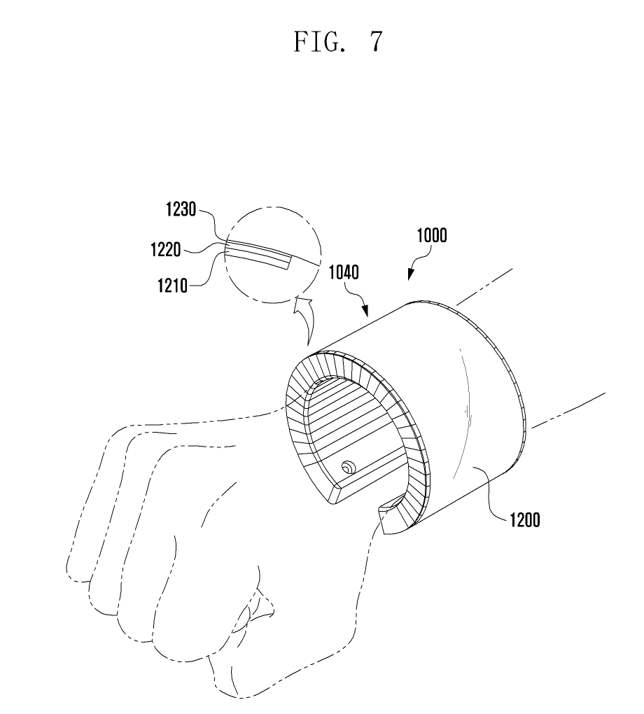

FIG. 7 is a diagram illustrating an example state in which an electronic device is worn on a wrist as a wearable device according to various example embodiments of the present disclosure.

With reference to FIG. 7, the electronic device 1000 according to various example embodiments of the present disclosure may be worn on a wrist as a wearable device. The display 1200 may be disposed at an upper portion of the housing 1040 formed by the upper support case frame 1100, the lower support case frame 1110, and the plurality of unit support case frames 1120.

According to an example embodiment, the display 1200 may include a flexible display panel 1210 or a transparent protection panel 1230 disposed at the outside of the flexible display panel 1210. Alternatively, the display 1200 may include a touch panel 1220 as an input. The touch panel 1220 may be disposed between the transparent protection panel 1230 and the flexible display panel 1210. The display 1200 may include various optical panels or optical films.

According to an example embodiment, the housing 1040 may be bent in a ring shape having a predetermined curvature. Alternatively, the housing 1040 may maintain a bent state or may be restored from a state bent in a ring shape to an original state.

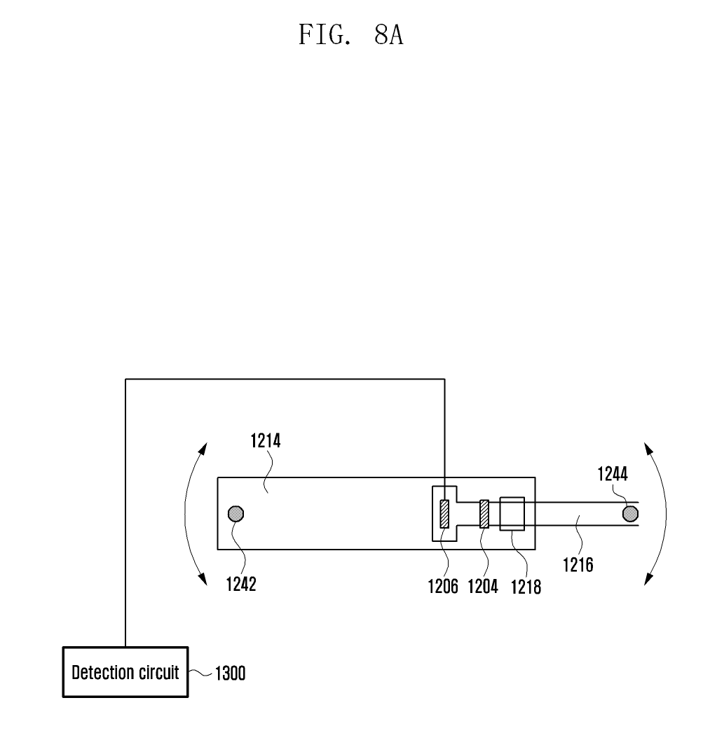

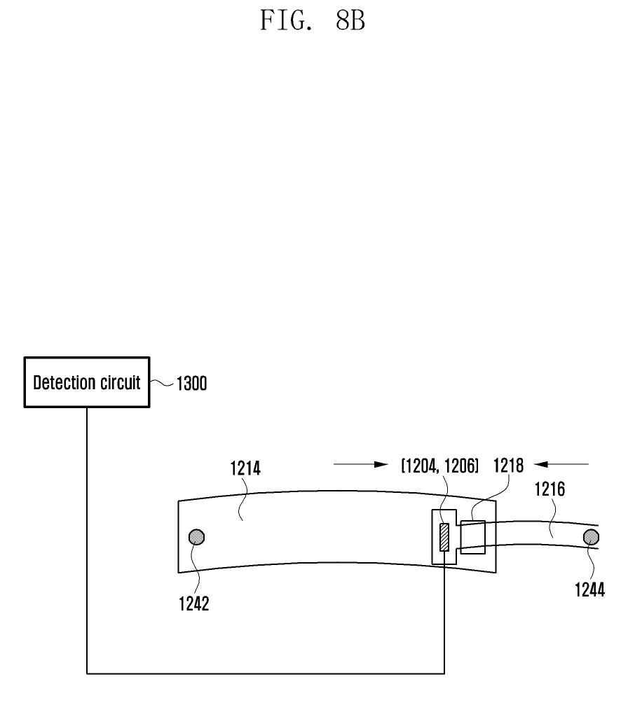

FIGS. 8A and 8B are schematic diagrams illustrating an example structure that detects bending of an electronic device according to various example embodiments of the present disclosure. FIG. 8A illustrates a flexible display panel in a flat state, and FIG. 8B illustrates a flexible display panel in a bent state.

With reference to FIG. 8A, the electronic device may include a first member 1214, second member 1216, and/or a detection circuit 1300. The first member 1214 may be attached and fixed to a first point 1242 of at least one of the constituent elements (e.g., a flexible display panel, a PCB) of the electronic device. The second member 1216 may be attached and fixed to a second point 1244 of at least one of the constituent elements (e.g., a flexible display panel, a PCB) of the electronic device. At least a portion of the first member 1214 and at least a portion of the second member 1216 may be overlapped. The detection circuit 1300 may detect a relative location of the first member 1214 and the second member 1216. According to an example embodiment, the first member 1214 and the second member 1216 may be attached to a rear surface of a flexible display or a PCB.

According to an example embodiment, the first member 1214 may include an electrode or a contact point 1204, which is a first conductive member. The second member 1216 may include an electrode or a contact point 1206, which is a second conductive member. Alternatively, the first member 1214 and the second member 1216 may include a Flexible Printed Circuit Board (hereinafter, FPCB).

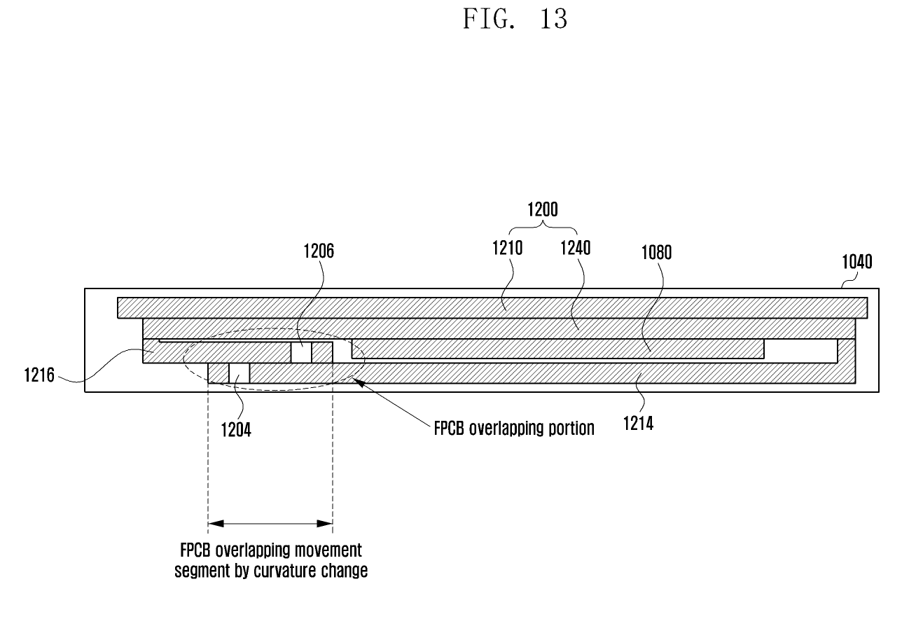

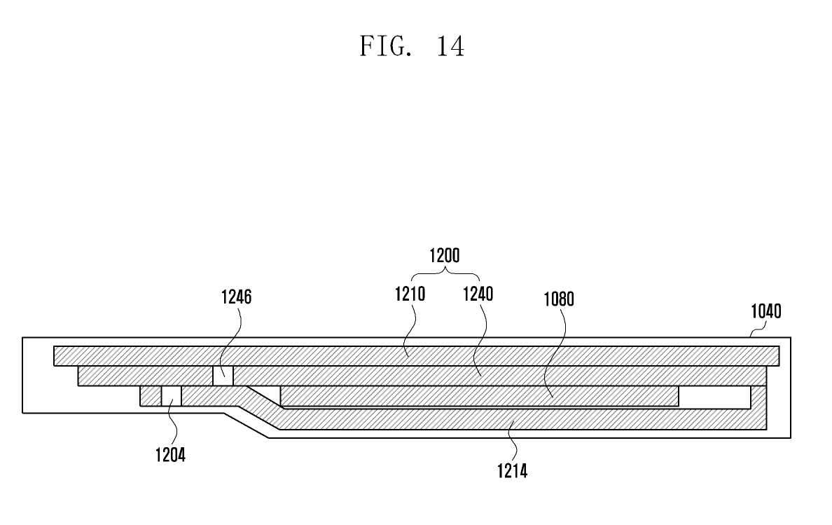

According to an example embodiment, one end of the first member 1214 may be fixed and connected to the first point 1242 of a PCB 1240 (see, e.g., FIGS. 13 and 14) using a fixing member such as a clip or a pin. One end of the second member 1216 may be fixed and connected to the second point 1244 of the PCB 1240 using a fixing member such as a clip or a pin. At least a portion of the other end of each of the first member 1214 and the second member 1216 may be slidably overlapped. The first member 1214 or the second member 1216 may include a guide 1218 that guides sliding of the first member 1214 or the second member 1216.

As illustrated in FIG. 8B, when the flexible display panel 1210 is bent, the first member 1214 and the second member 1216 are sliding guided by the guide 1218; thus, the electrodes or the contact points 1204 and 1206 may be bonded to each other.

When the electronic device is bent, the detection circuit 1300 may detect a relative location of the first member 1214 and the second member 1216 using that the electrode or the contact point 1204 of the first member 1214 is turned on/off from the electrode or the contact point 1206 of the second member 1216.

According to an example embodiment, when the housing 1040 of FIG. 7 is in a flat state before being bent, a distance between the first point 1242 of the first member 1214 attached to the display 1200 and the second point 1244 of the second member 1216 attached to the display 1200 may be referred to as a first distance. A changed distance between the first point 1242 and the second point 1244 when the housing 1040 is bent in any one direction may be referred to as a second distance.

According to various example embodiments of the present disclosure, one characteristic is that the first distance and the second distance are different.

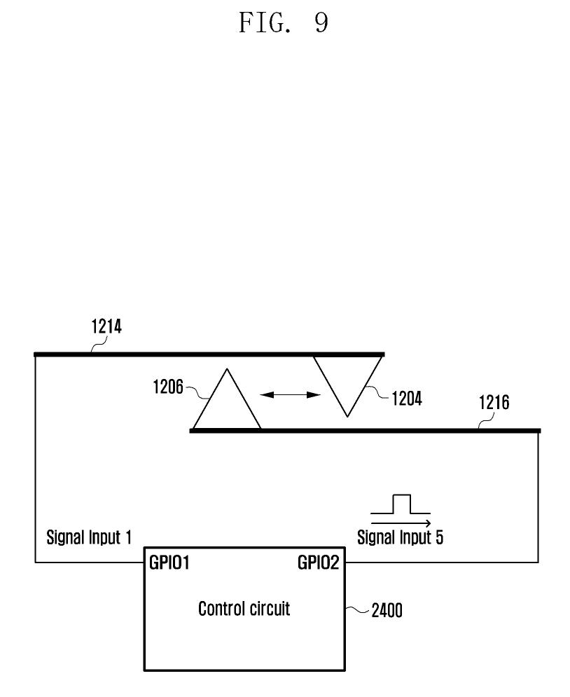

FIG. 9 is a circuit diagram illustrating a first example of a structure that detects bending of an electronic device according to various example embodiments of the present disclosure.

According to various example embodiments of the present disclosure, when the housing 1040 is in a flat state before being bent, the electrode or the contact point 1204 of the first member 1214 may be separated by a predetermined gap from the electrode or the contact point 1206 of the second member 1216. When the housing 1040 is bent in any one vertical direction, the first member 1214 or the second member 1216 slides (e.g., moves substantially laterally); thus, the electrode or the contact point 1204 of the first member 1214 may contact the electrode or the contact point 1206 of the second member 1216. The electrode or the contact points 1204 and 1206 may be in an active high or low state with a conductive material (e.g., lead). For example, when the electrodes or the contact points 1204 and 1206 are changed to a high or low state, it may be recognized that the housing 1040 is currently in a bent state. According to an example embodiment, sliding of the first member 1214 or the second member 1216 may be guided by the guide 1218 included in any one of the first member 1214 and the second member 1216.

According to various example embodiments of the present disclosure, a control circuit 2400 may detect a relative location of the first member 1214 and the second member 1216 using that the electrode or the contact point 1204 of the first member 1214 is turned on/off from the electrode or the contact point 1206 of the second member 1216.

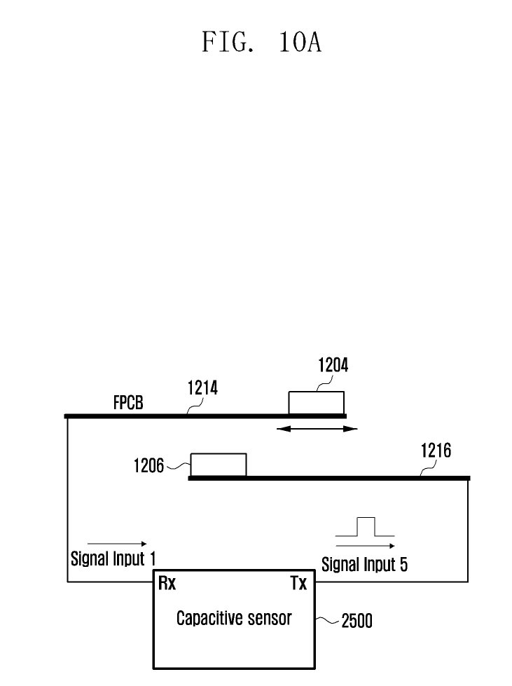

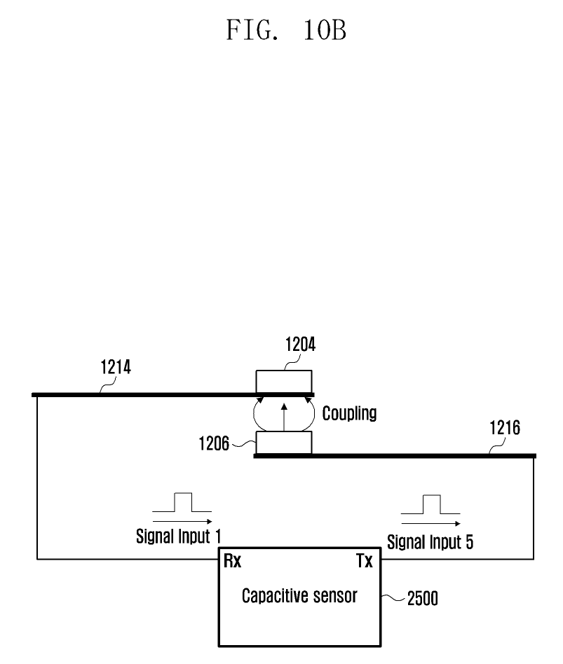

FIGS. 10A and 10B are circuit diagrams illustrating a second example of a structure that detects bending of an electronic device according to various example embodiments of the present disclosure.

With reference to FIG. 10A, when the housing 1040 is bent in any one vertical direction, the electrode or the contact point 1204 of the first member 1214, which is a first conductive member, is coupled to the electrode or the contact point 1206 of the second member 1216, which is a second conductive member; and, in this case, a relative location of the first member 1214 and the second member 1216 may be detected based on an electric signal flowing through the first conductive member and the second conductive member. According to an example embodiment, the first conductive member and the second conductive member may include a separated plurality of small conductive patterns.

According to an example embodiment, as illustrated in FIG. 10A, in a flat state of the housing 1040 before bending in which the electrode or the contact point 1204 of the first member 1214 is separated by a predetermined gap from the electrode or the contact point 1206 of the second member 1216, when the housing 1040 is bent in any one direction, and as illustrated in FIG. 10B, the electrode or the contact point 1204 of the first member 1214 approaches the electrode or the contact point 1206 of the second member 1216; thus, coupling may occur and a capacitive sensor 2500 may detect the coupling. Accordingly, a level may be determined in which the housing 1040 is bent in at least one direction based on a relative location of the first member 1214 and the second member 1216 detected by the capacitive sensor 2500.

According to an example embodiment, the electronic device may execute an operation of displaying at least one User Interface (UI) corresponding to a level in which the housing 1040 is bent in at least a portion of the display 1200 based on a determination of a bent level or adjusting at least one attribute information of the display 200. For example, when the housing 1040 is bent, the electronic device may stop power supply to the display 1200 or may change or adjust a UI based on a relative location of the first member 1214 and the second member 1216. For example, when the housing 1040 is unbent, the electronic device 1000 may detect that the electrode or the contact point 1204 of the first member 1214 and the electrode or the contact point 1206 of the second member 1216 are turned off to display a UI of a mobile terminal in at least a portion of the display 1200; and, when the electronic device 1000 is wound at a wrist, the electronic device 1000 may detect that the electrode or the contact point 1204 of the first member 1214 is turned on or coupled to the electrode or the contact point 1206 of the second member 1216 and display a UI of a watch.

According to various example embodiments of the present disclosure, when a receiving electrode, e.g., the electrode or the contact point 1204 of the first member 1214, is coupled to a transmitting electrode, e.g., the electrode or the contact point 1206 of the second member 1216, the capacitive sensor 2500 may detect a capacitance change formed between the first conductive member and the second conductive member. A relative location of the first member 1214 and the second member 1216 may be detected based on a capacitance change detected by the capacitive sensor 2500.

According to various example embodiments of the present disclosure, the first member 1214 may include at least one magnetic body. The second member 1216 may include a hall integrated circuit. The detection circuit 1300 may detect a relative location of the first member 1214 and the second member 1216 based on a change amount generated by the first member 1214, which is a magnetic body using a hall integrated circuit of the second member 1216.

According to various example embodiments of the present disclosure, the first member 1214 or the second member 1216 includes an optical sensor, and a relative location of the first and second members 1214 and 1216 may be detected using the optical sensor.

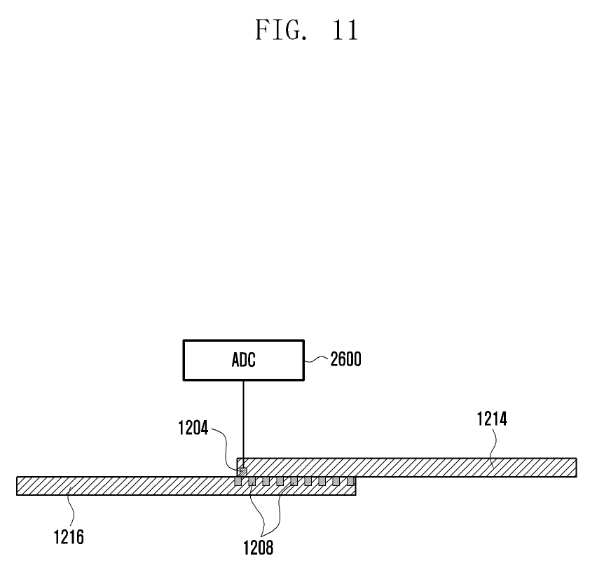

FIG. 11 is a diagram illustrating an example structure that detects bending of an electronic device according to various example embodiments of the present disclosure.

With reference to FIG. 11, according to various example embodiments of the present disclosure, the first member 1214 includes one electrode or contact point 1204, and the second member 1216 may include an Analog to Digital Converter (ADC) 2600 including a plurality of electrodes or contact points 1208. When the electrode or the contact point 1204 contacts any one of the plurality of electrodes or contact points 1208, a resistance value changes; thus, the ADC 2600 may recognize a relative location of the first member 1214 and the second member 1216 using a potential difference at each contact location.

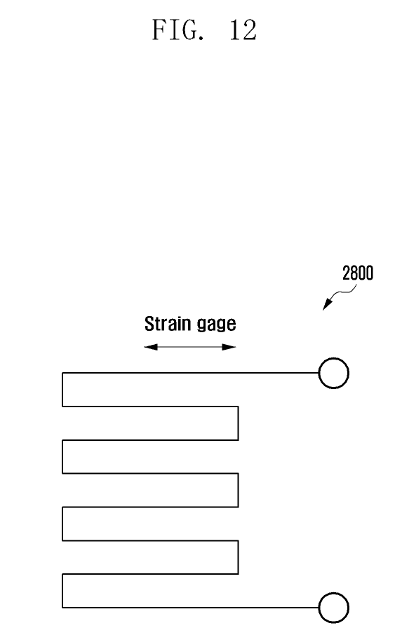

FIG. 12 is a diagram illustrating an example structure that detects bending of an electronic device according to various example embodiments of the present disclosure.

With reference to FIG. 12, according to various example embodiments of the present disclosure, a strain gauge 2800 may be attached to at least one of the first member 1214 and the second member 1216.

According to an example embodiment, the strain gauge 2800 may be classified into various kinds of an electrical strain gauge that measure in an electric type and a mechanical strain gauge that measures in a mechanical type. When the housing 1040 is bent, the second member 1216 slides from the overlapped first member 1214; thus, electric resistance between the first member 1214 and the second member 1216 changes and therefore the electrical strain gauge may measure a change rate thereof. The mechanical strain gauge mechanically measures a minute distance change between the first member 1214 and the second member 1216 to measure a change rate thereof, thereby detecting a relative location of the first and second members 1214 and 1216.

FIG. 13 is a cross-sectional diagram illustrating a first mounting example of a structure that detects bending of an electronic device according to various example embodiments of the present disclosure.

With reference to a first mounting example of FIG. 13, the housing 1040 includes the display 1200, and at an internal space thereof, various constituent elements, for example various electronic function groups 1080 of the electronic device 1000 may be mounted. The electronic device 1000 may include a flexible display panel 1210 and a main printed circuit board 1240 (hereinafter, an FPCB). With reference to FIG. 8A, the FPCB 1240 may include the first member 1214 attached and fixed to the first point 1242 using a clip or a pin, the second member 1216 slidably overlapped with at least a portion of the first member 1214 and attached and fixed to the second point 1244, and a detection circuit (not shown) that detects a relative location of the first member 1214 and the second member 1216.

According to an example embodiment of the present disclosure, an overlapping portion of the first member 1214 and the second member 1216 may be formed in a portion in which various electronic function groups 1080 are not mounted. The electrodes or the contact points 1204 and 1206 of the first member 1214 and the second member 1216 may contact by a curvature change in which the housing 1040 is bent. The electrodes or the contact points 1204 and 1206 may move within an overlapping portion of the first member 1214 and the second member 1216.

FIG. 14 is a cross-sectional diagram illustrating a second mounting example of a structure that detects bending of an electronic device according to various example embodiments of the present disclosure.

With reference to the second mounting example of FIG. 14, by forming the electrode or the contact point 1206 of the second member 1216 at the FPCB 1240 and by slidably overlapping the FPCB 1240 with at least a portion of the first member 1214, the electrode or the contact point 1204 of the first member 1214 contacts the electrode or the contact point 1246 formed at the FPCB 1240 by a curvature change in which the housing 1040 is bent; thus, a relative location of the first member 1214 and the FPCB 1240 may be detected. Therefore, the second member 1216 may be omitted; thus, an overlapping portion can be formed in a thin thickness.

Therefore, a mounting example of FIGS. 13 and 14 and various example embodiments of the present disclosure may be applied to various straps or bands such as a watch strap.

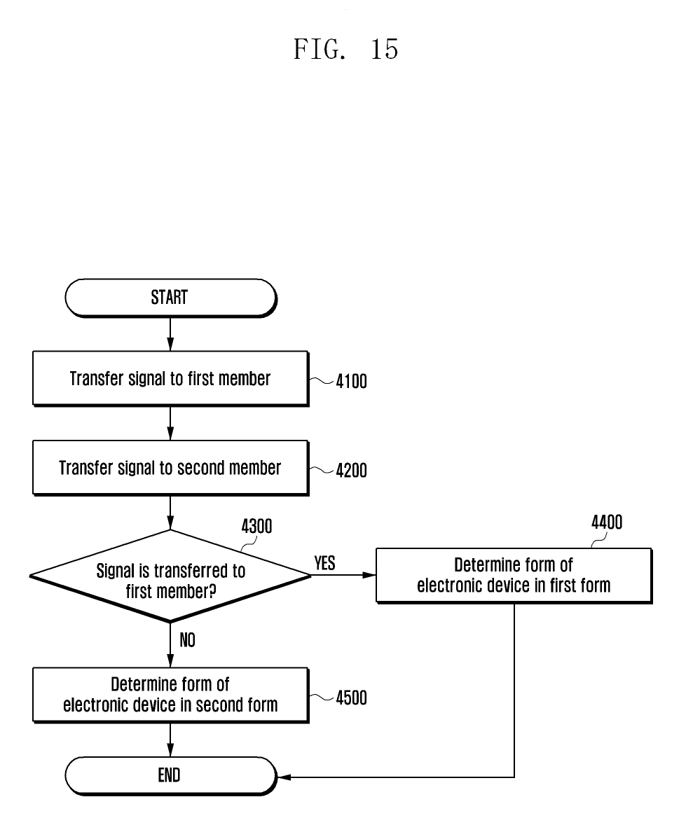

FIG. 15 is a flowchart illustrating an example method of recognizing a wearing form of an electronic device according to various example embodiments of the present disclosure.

A method of recognizing a form of an electronic device according to various example embodiments of the present disclosure may include operation 4100 of transferring a signal to a first member and operation 4200 of transferring a signal to a second member.

According to an example embodiment, the first member and the second member may include a first conductive member and a second conductive member, respectively, and a relative location of the first member and second member may be detected based on an electric signal flowing through the first and second conductive members.

A method of recognizing a form of an electronic device according to various example embodiments of the present disclosure may include operation 4400 of determining a form of an electronic device to be in a first form and operation 4500 of determining a form of an electronic device to be in a second form according to operation 4300 of determining whether a signal is transferred to a first member.

When the electronic device detects that a signal is transferred to the first member, a wearing form of the electronic device is determined to be in a first form, and when the electronic device detects that a signal is not transferred to the first member, a wearing form of the electronic device may be determined to be in a second form different from the first form.

As described above, the electronic device according to the present disclosure comprises: a housing that bends in at least one direction; a first member fixed to the housing or a first point within the housing; a second member fixed to the housing separated in the at least one direction from the first point or a second point within the housing and slidably overlapping at least a portion of the first member; and a detection circuit configured to detect a relative location of the first member and the second member, wherein a first distance between the first point and the second point when the housing is in a flat state is different from a second distance between the first point and the second point when the housing is in a bent state in the at least one direction.

The electronic device may further comprise a control circuit electrically connected to the detection circuit, wherein the control circuit determines a level in which the housing is bent in the at least one direction based on a relative location of the first member and the second member detected by the detection circuit.

The control circuit may execute at least one action based on the determination.

The electronic device may further comprise a display, wherein the at least one action comprises an action that displays at least one user interface corresponding to a level in which the housing is bent in at least a portion of the display or that adjusts at least one attribute information of the display.

The first member may include a first conductive member, and the second member may include a second conductive member.

The detection circuit may detect a relative location of the first member and the second member based on an electric signal flowing through the first conductive member and the second conductive member.

A relative location of the first member and the second member may be detected based on a capacitance change formed between the first conductive member and the second conductive member.

The first conductive member or second conductive member may include a separated plurality of small conductive patterns.

The first member may include at least one magnetic body, and he second member may include a hall integrated circuit, and the detection circuit detects a relative location of the first member and the second member based on a change of a magnetic field generated by the magnetic body using the hall integrated circuit.

The first member or the second member may include a flexible printed circuit board.

The electronic device may further comprise a strain gauge attached to at least one of the first member and the second member.

A method of recognizing a form of an electronic device comprising a housing bent in any one direction, a first member fixed to the housing or within the housing, and a second member slidably overlapped with at least a portion of the first member may comprises: detecting a relative location of the first and second members according to folding and rolling states of the housing; and determining a level in which the housing is bent in the any one direction based on the relative location of the first member and the second member.

A relative location of the first member and the second member may be detected based on an electric signal flowing through the first and the second conductive member or based on a capacitance change formed between the first and second conductive member.

As described above, in an electronic device and a method of determining a wearing form thereof according to an example embodiment of the present disclosure, when a detection circuit determines and detects a bent state such as folding and rolling of a display with an area, a time, and a pressure, the control circuit may stop power supply to the display and change or adjust a UI according to a detected result to have a UI of a mobile terminal in at least a portion of the display or may wind the electronic device at a wrist to have a UI of a watch.

According to various example embodiments of the present disclosure, because two internal FPCBs use on/off of an electrode or a contact point according to a bending operation, a magnetization problem due to a magnet can be avoided and a mounting space of a PCB can be saved because of a magnet recognition sensor (e.g., a Hall sensor).

According to various example embodiments of the present disclosure, because an operation state of a display may be recognized using an internal FPCB, rolling and folding states can be determined by an analog method.

According to various example embodiments of the present disclosure, when winding and wearing an electronic device at a wrist, by reacting to bending detection, a User Interface (UI) can be adjusted.

The example embodiments disclosed in the description and drawings are merely presented to easily describe technical contents of the present disclosure and to aid in understanding of the present disclosure and are not intended to limit the scope of the present disclosure. Therefore, all changes or modifications derived from the technical idea of the present disclosure as well as the example embodiments described herein should be interpreted to belong the scope of the present disclosure.

What is claimed is:

1. An electronic device, comprising:
a housing configured to bend in at least one direction;
a first member comprising a first surface, said first member fixed to the housing or to a first point within the housing;
a second member comprising a second surface, said second member fixed to the housing separated in the at least one direction from the first point or a second point within the housing, at least a portion of the second member arranged to overlap with at least a portion of the first member, at least one of the first and second members being configured to move relative to the other member; and
a detection circuit configured to detect a relative location of the first member and the second member,
wherein a first distance between the first point and the second point when the housing is in a flat state is different from a second distance between the first point and the second point when the housing is in a bent state in the at least one direction.

2. The electronic device of claim 1, further comprising a control circuit electrically connected to the detection circuit,
wherein the control circuit is configured to determine a level in which the housing is bent in the at least one direction based on a relative location of the first member and the second member detected by the detection circuit.

3. The electronic device of claim 2, wherein the control circuit is configured to perform at least one action based on the determination.

4. The electronic device of claim 3, further comprising a display,
wherein the at least one action comprises an action that displays at least one user interface corresponding to a level in which the housing is bent in at least a portion of the display or that adjusts at least one attribute information of the display.

5. The electronic device of claim 1, wherein the first member comprises a first conductive member, and
the second member comprises a second conductive member.

6. The electronic device of claim 5, wherein the detection circuit is configured to detect a relative location of the first member and the second member based on an electric signal flowing through the first conductive member and the second conductive member.

7. The electronic device of claim 5, wherein a relative location of the first member and the second member is detected based on a capacitance change between the first conductive member and the second conductive member.

8. The electronic device of claim 5, wherein the first conductive member or second conductive member comprises a plurality of spaced apart conductive patterns.

9. The electronic device of claim 1, wherein the first member comprises at least one magnetic body,
the second member comprises a hall integrated circuit, and
the detection circuit is configured to detect a relative location of the first member and the second member based on a change of a magnetic field generated by the magnetic body using the hall integrated circuit.

10. The electronic device of claim 1, wherein the first member or the second member comprises a flexible printed circuit board.

11. The electronic device of claim 1, further comprising a strain gauge attached to at least one of the first member and the second member.

12. A method of recognizing a bending state of an electronic device comprising a housing bent in any one direction, a first member comprising a first surface fixed to the housing or within the housing, and a second member comprising a second surface, the second member arranged to overlap at least a portion of the first member, at least one of the first and second members being arranged to move relative to the other member, the method comprising:
detecting a relative location of the first and second members based on one or more of folding and rolling states of the housing; and
determining a level in which the housing is bent in the any one direction based on the relative location of the first member and the second member.

13. The method of claim 12, wherein the first member comprises a first conductive member, and the second member comprises a second conductive member.

14. The method of claim 13, wherein a relative location of the first member and the second member is detected based on an electric signal flowing through the first and the second conductive member or based on a capacitance change between the first and second conductive member.

15. The method of claim 13, wherein a relative location of the first member and the second member is detected based on a capacitance change between the first conductive member and the second conductive member.

16. The method of claim 12, wherein the first member comprises at least one magnetic body, and
the second member comprises a hall integrated circuit,
wherein a relative location of the first member and the second member is detected based on a change of a magnetic field generated by the magnetic body using the hall integrated circuit.

17. The method of claim 12, wherein the first member comprises one electrode or contact point, and the second member comprises an Analog to Digital Converter (ADC) comprising a plurality of electrodes or contact points, and
the ADC detects a relative location of the first member and the second member based on a potential difference at each bonding location, when an electrode or a contact point of the first member bonds to any one of a plurality of electrodes or contact points of the second member.

18. The method of claim 12, further comprising a strain gauge attached to at least one of the first member and the second member,
wherein the strain gauge detects a relative location of the first member and the second member based on a change rate when the second member moves relative to the overlapped first member based on bending of the housing.

19. The method of claim 12, wherein at least one action is executed based on determination of a level in which the housing is bent in the at least one direction.

20. The method of claim 19, wherein the at least one action comprises an action that displays at least one user interface corresponding to a level in which the housing is bent in at least a portion of a display of the electronic device or that adjusts at least one attribute information of the display.
